(19) United States
(12) Patent Application Publication
(10) Pub. No.: US 2004/0199905 A1
(43) Pub. Date: Oct. 7, 2004

(54) System and method for translating data from a source schema to a target schema

(75) Inventors: Ronald Fagin, Los Gatos, CA (US); Mauricio Antonio Hernandez-Sherrington, Gilroy, CA (US); Renee J. Miller, Toronto (CA); Lucian Popa, San Jose, CA (US); Ioannis Velegrakis, Toronto (CA)

Correspondence Address: Samuel A. Kassatly, 6819 Trinidad Drive, San Jose, CA, 95120, US

(73) Assignee: International Business Machines Corporation, Armonk, NY

(21) Appl. No.: 10/404,752

(22) Filed: Apr. 1, 2003

(51) Int. Cl. G06F 9/44

(52) U.S. Cl. 717/136; 717/140; 717/114

(57) ABSTRACT

The present system imports data from a source schema into a target schema while keeping the semantics, structure, and constraints of the data intact. The system is driven by user inputs that define a set of correspondences between the source schema and the target schema. The system meets the requirement that data produced at the target not violate the schema of the target; rather, the data must conform to the target schema. The system can be applied in both target materialization and query unfolding, producing all the meaningful queries required in data translation by finding all the associations that exist in the schemas. Each query maps from a source association to a target association. The user selects a subset of those queries that match the desired data translation. Target constraints are taken into account by the present system to infer the user intention and to guarantee that the generated data satisfies the structure and constraints of the target schema. Fields required by the target schema that are not provided by the source schema are automatically populated by the present system. The target instance is guaranteed to be in partition normal form.

### FIELD OF THE INVENTION

The present invention generally relates to the field of data processing, and particularly to a software system and associated method for use with possibly dissimilar databases to transfer data from at least one data source with a relational, or XML schema, to a target schema. More specifically, this invention pertains to a method for translating a high-level user specified mapping into semantically meaningful queries that transform source data into the target representation.

### BACKGROUND OF THE INVENTION

The WWW, or Internet, is comprised of an expansive network of interconnected computers upon which businesses, governments, groups, and individuals throughout the world maintain inter-linked computer files known as web pages. The volume of data available on the Internet is increasing daily, but the ability of users to understand and transform this data has not kept pace. Businesses need the ability to capture and manipulate data available on the Internet for such applications as data warehousing, global information systems, and electronic commerce.

E-commerce and other data-intensive applications rely on the ability to capture, use, and integrate data from multiple sources. To transform data from one structure or schema to another, mappings must be created between the data source (or set of heterogeneous data sources) and a target or integrated schema. While important advances have been made in the ability to create and manage these mappings, a number of important issues remain.

One important issue in modern information systems and e-commerce applications is providing support for inter-operability of independent data sources. A broad variety of data is available on the Internet in distinct heterogeneous sources, stored under different formats: database formats (e.g., relational model), semi-structured formats (e.g., DTDs, SGML or XML Schema), scientific formats, etc. Integration of such data is an increasingly important problem. The effort involved in such integration is considerable. Translation of data from one format or schema to another requires writing and managing complex data transformation programs or queries.

The schema-mapping problem involves translating data from one independently created schema (a source schema) to another independently created schema (a target). The schemas may have different semantics, and this may be reflected in differences in their logical structures and constraints. Most current work on data integration focuses on schema integration, where the target (global) schema is created from one or more source (local) schemas. The target is created to reflect the semantics of the source and has no semantics of its own. In current schema mapping solutions, a source schema with a rich logical structure is typically mapped into a flat, single table target schema with no constraints.

The source and target schema may not represent the same data. There may be source data that is not represented in the target, and should thus be omitted in the translation or mapping process. However, there may be a need in the target schema for data that are not represented in the source schema. In some cases, values must be produced for undetermined elements or attributes in the target schema, i.e., target elements for which there is no corresponding source element. Values may be needed if the target element can not be null, such as elements in a key, and no default is given. More importantly, the creation of new values for such target elements is essential for ensuring the consistency of the target data. For example, foreign keys in the target may need to be created to ensure that source data is correctly mapped.

The problem of creating data in the target schema that is not represented in the source schema has been addressed by specialized translation languages that include Skolem functions for value creation. However, currently available schema mapping systems have not considered the problem of automatically determining a correct set of Skolem functions that respects the target constraints and preserves information in a translation.

What is needed is a comprehensive solution to building, refining and managing transformations between heterogeneous schemas. This solution should handle not only relational data but also data represented in nested data models that are commonly available on the Internet. The semantic relationships should be preserved during the translation from source to target, where the source and target schemas may contain very rich, yet highly heterogeneous constraints. In addition, the solution should automatically determine a correct set of Skolem functions for the translation of data from the source to the target schema that guarantees that the translated data satisfies the nested structure and constraints of the target schema. The need for such a system has heretofore remained unsatisfied.

### SUMMARY OF THE INVENTION

The present invention satisfies this need, and presents a system, a computer program product, and an associated method (collectively referred to herein as “the system” or “the present system”) for translating data from a source schema to a target schema. The goal of the present system is to import data from a source schema into a target schema while keeping the semantics, structure, and constraints of the data intact. The process of the present system is driven by user inputs that define a set of correspondences between the source schema and the target schema. The present system meets the requirement that data produced at the target not violate the schema of the target. Rather, the data must conform to the target schema. The present system can be applied in both target materialization and query unfolding.

The present system produces all the meaningful queries required in data translation by finding all the associations that exist in the schemas. Each query maps from a source association to a target association. The user selects a subset of those queries that match the desired data translation. Target constraints are taken into account by the present system to infer the user intention and to guarantee that the generated data satisfies the structure and constraints of the target schema. The target instance is guaranteed to be in partition normal form.

To perform schema mapping, the present system seeks to interpret the correspondences in a manner that is consistent with the semantics of both the source and target schemas. This interpretation process is semantic translation. Since the semantics used are encoded in logical structures, the resulting interpretation is a logical mapping. The present system uses the simplest form of correspondence, element (i.e., attribute) correspondences. An element correspondence is a pair of a source element and a target element.

Although semantically impoverished, simple element correspondences are used for several reasons. First, element correspondences are independent of logical design choices such as the grouping of elements into tables (normalization choices) or the nesting of records or tables. An example of the nesting of records or tables might be the hierarchical structure of an XML schema.

Consequently, by using element correspondences the logical access paths (join or navigation) that define the associations between elements involved need to be specified. Even users unfamiliar with the complex structure of the schema can provide such correspondences. In addition, automated techniques for schema matching have proven to be very successful in extracting such correspondences. The present system uses a modular design allowing the use of any schema-matching component. The present system uses an automated attribute matcher to suggest correspondences and provides a graphical user interface (GUI) to permit users to augment or correct those correspondences.

While relatively easy to create and manipulate, element correspondences are inherently ambiguous. There may be many translations consistent with a set of correspondences, and not all have the same effect. The present system finds among the many possible translations those that are consistent with the constraints of the schemas.

The present system makes use of the semantic information from the source schema to determine which combinations of values are meaningful. In addition, the present system uses semantic information expressed in the target schema to correctly populate the target. There are many semantic associations I a schema, and even the same set of elements could be associated in more than one way. The choice may depend on semantics that are not represented in the source schema and must instead be given by a user.

Analyzing data semantics can be a time consuming process for large schemas. The present system supports incremental creation and modification of mappings. Consequently, it is important that such modifications be made efficiently. To accomplish this goal, the present system compiles the semantics of the schemas into a convenient data structure that represents the semantic relationships imbedded in each schema. Using this compiled form, the semantic translation algorithm of the present system efficiently interprets correspondences.

The semantic translation algorithm of the present system provides an interpretation of the correspondences that is faithful to the semantics of the schemas. In addition, the present system enumerates all such faithful interpretations, called logical mappings. Enumeration of all such mappings is an essential ingredient of the present system. Any one, any subset, or all of the mappings could correspond to the user's intentions for a given pair of schemas and their correspondences. The entire process of semantic translation is therefore a semi-automatic process.

The present system generates all logical mappings consistent with the schema representations; the user chooses a subset of these mappings. To reduce the burden on the user, the present system orders the mappings allowing users to focus on the most likely mappings. A data viewer is provided that uses carefully chosen data examples to help explain each mapping.

The next translation phase is data translation, in which the present system generates an implementation of the logical mappings. The result of this phase is a set of internal rules, one for each logical mapping. These rules have a direct translation as external queries, and the present system provides query wrappers for XQuery and XSLT (in the XML case). To correctly translate data, values may need to be produced for undetermined target elements and the data may need to be nested according to the target structure.

The present system supports nested structures in the source and target schemas. These nested structures may comprise a nested relational model and nested constraints. The element correspondences are presented in a user-friendly method, enabling automatic discovery. The present system captures the user's intentions in data translation from the source schema to the target schema. The present system preserves data meaning as it is translated, discovering associations and using constraints and the schemas to preserve data meaning. In addition, the present system creates new target values as needed, and produces the correct grouping of data within the target schema.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system and method for translating data from a source schema to a target schema of the present invention can be used;

FIG. 2 is a block diagram illustrating the high-level architecture for the data-driven understanding and refinement of data translation system of FIG. 1;

FIG. 3 is a process flow chart illustrating a method of operation of the data translation system of FIGS. 1 and 2;

FIG. 4 is a block diagram illustrating the method of discovering intra-schema associations between schema elements of the data translation system of FIGS. 1 and 2;

FIG. 5 is a process flow chart illustrating a method of operation of the intra-schema association discovery step of the method of operation of the data translation system of FIGS. 1 and 2;

FIG. 6 is a process flow chart illustrating a method of generating logical mapping by the data translation system of FIGS. 1 and 2; and

FIG. 7 is a process flow chart illustrating a method of generating queries by the data translation system of FIGS. 1 and 2.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Atomic: Indivisible. An atomic operation, or atomicity, implies an operation that must be performed in its entirety or not at all. For example, if machine failure prevents completion of a process, the system will be rolled back to the start of the transaction.

DTD: Document Type Definition. A manner of describing the structure of an XML or SGML document and how the document relates to other objects.

Join: In relational databases, a join operation matches records in two tables. The two tables must be joined by at least one common field; i.e. the join field is a member of both tables. Typically, a join operation is part of a SQL query.

Leaf: Terminal node of a tree; a node with no child/daughter.

Internet: A collection of interconnected public and private computer networks that are linked together with routers by a set of standard protocols to form a global, distributed network.

Instance: In object-oriented technology, a member of a class; for example, “Lassie” is an instance of the class “dog.” When an instance is created, the initial values of its instance variables are assigned.

Node: Refers to an element, or object that can be expanded to show underlying objects.

Record/Tuple: In database management systems, a set of information. Records are composed of fields, each of which contains one item of information. A set of records constitutes a file. For example, a personnel file might contain records that have three fields: a name field, an address field, and a phone number field. A record corresponds to a row in a table.

Path: The sequence of nodes encountered in the route between any two nodes (inclusive).

Schema: Format or structure. It defines the structure and type of contents of constituent structures of, for example, a relational database, XML documents, etc.

SGML: Standard Generalized Markup Language. A generic language for writing markup languages. SGML makes possible different presentations of the same information by defining the general structure and elements of a document.HTML (Hypertext Markup Language) is based on SGML.

Tree: A hierarchical structure made up of nodes. Nodes are connected by edges from one node (parent) to another (child). A single node at apex of the tree is known as the root node, while the terminus of a path in the opposite direction is a leaf.

XQuery: XML QUERY Language. A language for querying XML documents from the W3C. Compatible with related W3C standards (XML Schema, XSLT, etc.), XQuery was derived from the XPath language and uses the same syntax for path expressions. Based on the XQuery data model, XQuery processes the query by parsing the XML document, the schema and the query into hierarchical node trees. It also generates an output schema with the query results. XQuery is expected to become as popular for querying XML documents as SQL is for relational databases.

XSD: XML Schema Definition Language. A language, standardized by the W3C, for defining the structure, content and semantics of XML documents. An XML schema describes an XML document in a similar way a relational schema describes a relational database. However, an XML Schema offers more flexibility and expressive power than a relational schema. As XML becomes more popular, XML Schemas are expected to become as popular and widespread as relational schemas.

XSLT: Extensible Style Language Transformation. It is the language used by .XML style sheets to transfer one form of an .XML document to another .XML form. This transition is useful in e-commerce and e-business, as it serves as a common denominator across many different platforms and varying .XML document coding.

XML: extensible Markup Language. A standard format used to describe semi-structured documents and data. During a document authoring stage, XML “tags” are embedded within the informational content of the document. When the XML document is subsequently transmitted between computer systems, the tags are used to parse and interpret the document by the receiving system.

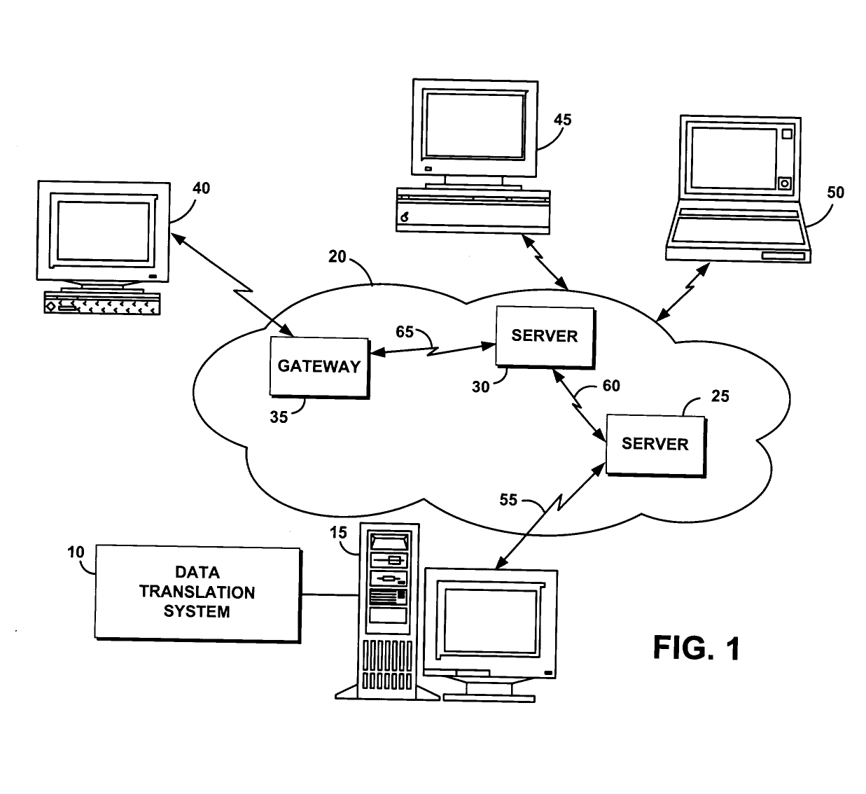

FIG. 1 portrays an exemplary overall environment in which a system and associated method for translating web data according to the present invention may be used. System 10 includes a software programming code or computer program product that is typically embedded within, or installed on a host server 15. Alternatively, system 10 can be saved on a suitable storage medium such as a diskette, a CD, a hard drive, or like devices. While the system 10 will be described in connection with the WWW, the system 10 can be used with a stand-alone database of terms that may have been derived from the WWW and/or other sources.

The cloud-like communication network 20 is comprised of communication lines and switches connecting servers such as servers 25, 30, to gateways such as gateway 35. The servers 25, 30 and the gateway 35 provide the communication access to the WWW or Internet. Users, such as remote Internet users, are represented by a variety of computers such as computers 40, 45, 50, and can query the host server 15 for desired information through the network 20. Computers 40, 45, 50 each include software that will allow the user to browse the Internet and interface securely with the host server 15. The host server 15 is connected to the network 20 via a communications link 55 such as a telephone, cable, or satellite link. The servers 25, 30 can be connected via high-speed Internet network lines 60, 65 to other computers and gateways.

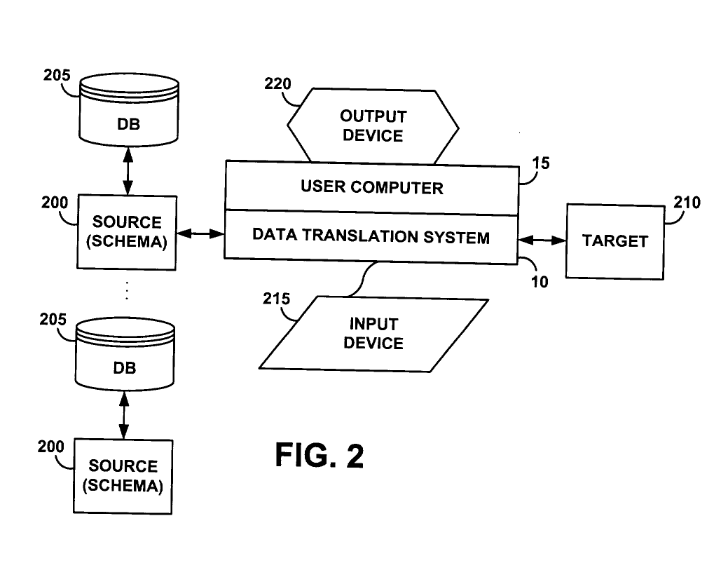

FIG. 2 illustrates the high-level architecture showing the data translation system 10 used in the context of an Internet or Intranet environment. A data source such as a schema 200 with associated database 205 stores data in a source schema while the data target stores data in the target schema 210. The database 205 may reside in a Web server or other location remote from the user computer 15 and may be accessible via a wide area network such as, but not limited to, an Internet.

As shown in FIG. 2, the computer 15 is electrically or optically connected to one or more input devices 215 such as a mouse or keyboard which are manipulated by the user to interact with the schema mapping system 10. The results of the system 10 execution can be output via an output device 220 such as a printer or monitor that are connected to the user computer 15.

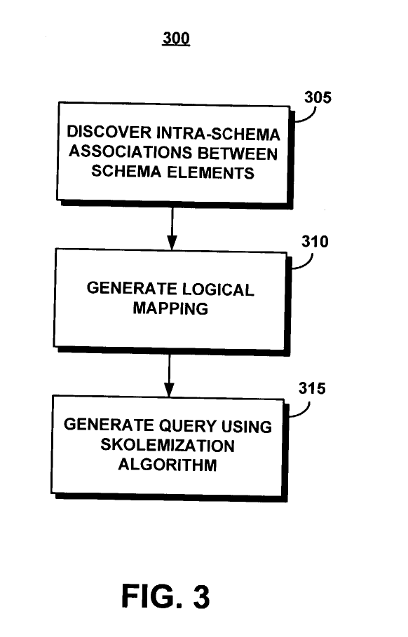

FIG. 3 illustrates the method 300 of the high-level operation of system 10. System 10 discovers the intra-schema associations between schema elements at block 305. In discovering these associations, system 10 captures all the data in the source schema and target schema in a simplified schema, consisting of a set of primary paths. System 10 takes then each primary path of the simplified schema and chases it with the referential integrity constraints, computing a set of associations that show how different elements in the schema are related.

At block 310, system 10 performs logical mapping generation. User input to logical mapping generation is a set of correspondences between elements. It is possible that two correspondences involve elements that are associated. The user draws the two correspondences using existing tools. Prior art would map each correspondence independent of the remaining correspondences in isolation from other correspondences, losing the association that exists.

System 10 preserves such associations because the correspondences are based on block 305 that computes the data structure that relates such elements. Consequently, system 10 locates the two correspondences that are associated and correctly relates them.

System 10 then performs query generation at block 315 using a skolemization algorithm. The logical mapping is a flat representation of how the schemas correspond. Not all target attributes are determined by the source. System 10 materializes the nested target through the skolemization algorithm.

The skolemization algorithm is the primary means for query generation by system 10, achieving good nesting or grouping and generating new values such as ids. The skolem functions control the creation of unknown elements such as atomic values and sets. The atomic values enforce the integrity of the target and the sets control how elements are grouped in the target. These skolem functions are automatically generated.

For each inter-schema constraint, system 10 generates a query that extracts data from a source and uses this data to populate the target. The search result in response to the query will be used to populate the target. The end result of the method of system 10 is a set of queries either in XSLT or XQuery, query languages.

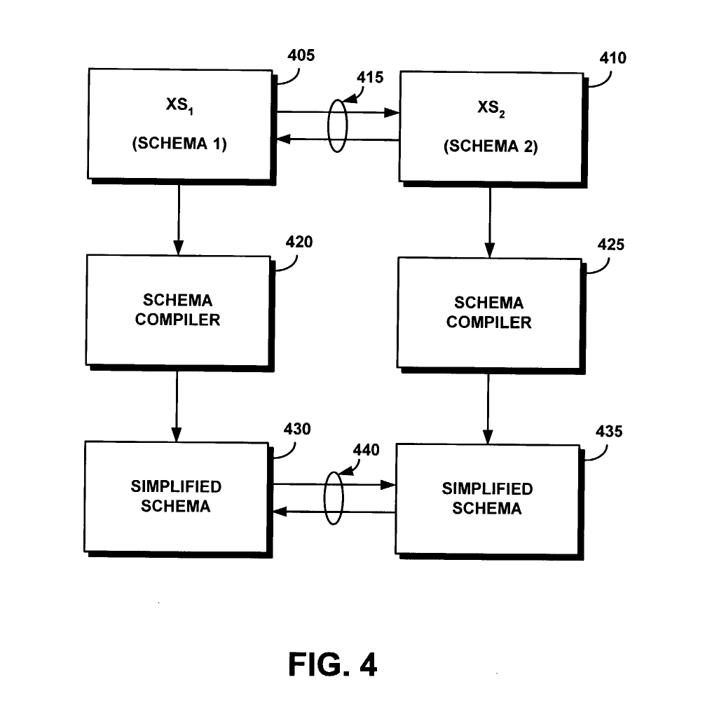

The method of block 305 is further illustrated in FIG. 4. A schema defines a set of formats and also defines relationships between elements called referential constraints. The desired data translation between the source schema, schema 1 405, and target schema, schema 2 410, can be represented a set of correspondences 415 between the two schemas.

However, these correspondences are very complex, and may contain nested attributes and constraints that can't be easily mapped from schema 1 405 to schema 2 410. In addition, schema 2 410 may have data requirements such as foreign keys that are not contained in schema 1 405. To simplify the correspondences and discover nested attributes, constraints, and fields required by schema 2 410, the present system uses a schema compiler.

Schema compiler 420 compiles the source schema, schema 1 405, and schema compiler 425 compiles the target schema, schema 2 410. The output of schema compiler 420 is a simplified schema 1 430. The output of schema compiler 425 is a simplified schema 2 435. The correspondences 415 are also complied to create the simplified correspondences 440 between the two simplified schemas, schema 1 430 and schema 2 435. Simplified schema 1 430, schema 2 435, and correspondences 440 are used in the logical mapping generation of system 10.

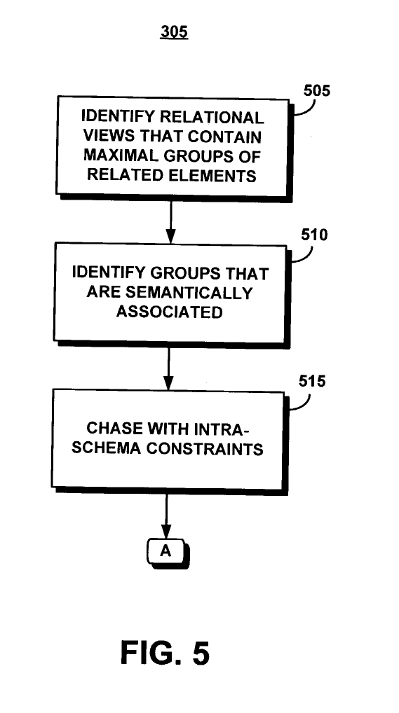

The method of block 305 of FIG. 3 is further expanded in the process flow chart of FIG. 5. System 10 identifies relational views that contain maximal groups of related elements. Each relational view represents a different category of data that may exist in the database. At block 505, system 10 compiles each schema into nested relationships comprising a set of primary paths.

For a relational schema, there is a primary path for each individual relation. For a nested schema, the primary paths are obtained by constructing a tree with a node at each set type in the schema, and with an edge between two nodes, whenever the first node is a set type that contains the second.

A primary path is then the set of all elements found on a path from the root to any intermediate node or leaf in this tree. System 10 then identifies groups that are semantically associated. At block 510, system 10 computes the set of associations (or categories) for each schema by chasing the primary paths with the referential constraints in the XSD schema.

Each association is a relational view of the schema that groups together elements of the schema that are semantically associated. In addition, each association describes one category of data that can exist in an instance without violating the respective schema.

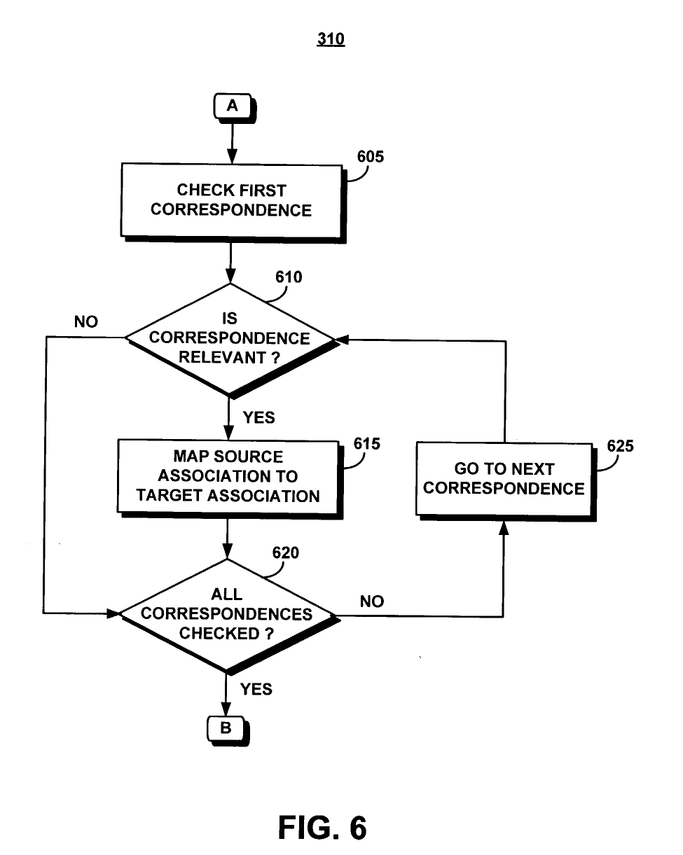

The method of block 310 of FIG. 3 is further expanded in the process flow chart of FIG. 6. Similar to the process of creating a source association, system 10 creates a target association, as well. An inter-schema constraint is a logical assertion that all the elements of the source association that are covered by correspondences are moved into the target as elements of the target association. The first correspondence is checked at block 605.

At decision block 610, system 10 verifies that the correspondence is relevant to the logical mapping. If the correspondence is relevant, system 10 maps the source association to the target association at block 615. System 10 then proceeds to decision block 620 and determines whether all correspondences have been checked, If the correspondence was not relevant at decision block 610, system 10 would proceed directly to decision block 620. If additional correspondences remain to be checked, system 10 proceeds to the next correspondence at block 625, repeating blocks 610 through 620 until all correspondences have been checked and logical mapping is complete. By construction, the logical mappings preserve associations between the elements.

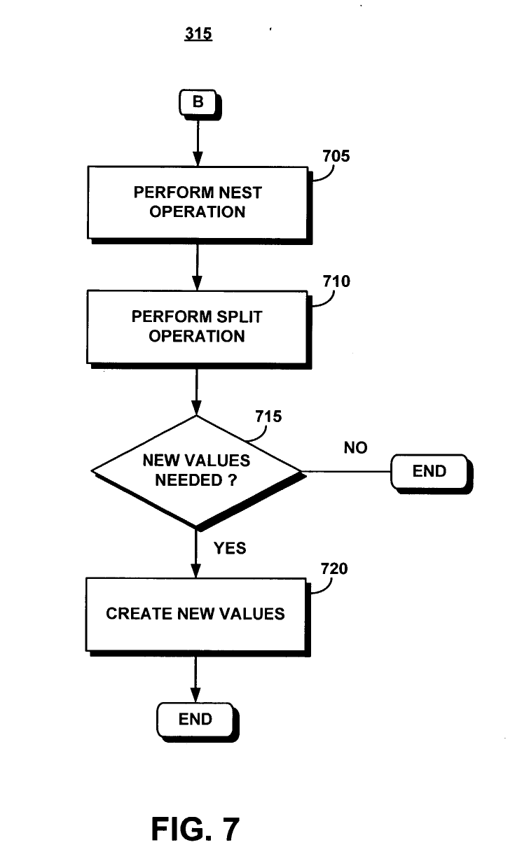

The method of block 315 of FIG. 3 is further expanded in the process flow chart of FIG. 7. System 10 finds the first inter-schema constraint at block 705. At block 710, system 10 generates a query using a skolemization algorithm that implements the inter-schema constraint at the data instance level. When given a source data instance, the query transforms all data under the category corresponding to the source association into data under the category corresponding to the target association.

System 10 performs a nest operation, unnesting data in the source and nesting data in the target according to the target structure. System 10 then performs a split operation splitting data as needed to match the target schema. System 10 then determines if additional inter-schema constraints remain (decision block 715).

If so, system 10 proceeds to the next inter-schema constraint at block 720 and repeats steps 710 and 715 until no additional inter-schema constraints remain. When all inter-schema constraints have been processed, system 10 determines whether new values are needed in the target schema at decision block 725. If so, system 10 creates those new values at block 730. For example, to populate a target schema, an id may be required that may be neither null nor arbitrary.

As is often the case with elements that carry structural information but no real data, there is no correspondence that maps into the id from the source. System 10 invents id values in a manner that maintains source data associations at block 720. The translation of data from a source schema to a target schema is now complete.

It is to be understood that the specific embodiments of the invention that have been described are merely illustrative of certain application of the principle of the present invention. Numerous modifications may be made to the system and method for translating data from a source schema to a target schema invention described herein without departing from the spirit and scope of the present invention. Moreover, while the present invention is described for illustration purpose only in relation to mapping data from one schema to another, it should be clear that the invention is applicable as well to any collection of data or databases accessible either through an internet or intranet connection.

What is claimed is:

1. A method of translating data from a source schema to a target schema, comprising:
compiling the source schema;
compiling the target schema;
translating a set of user specified correspondences from a plurality of elements of the source schema into a plurality of inter-schema constraints; and
translating the inter-schema constraints to a plurality of queries for translating the data.

2. The method of claim 1, wherein compiling the source schema and the target schema comprises discovering a plurality of associations within the source schema and the target schema based on a plurality of referential constraints.

3. The method of claim 1, further comprising compiling the source schema and the target schema into a nested relational representation comprising a set of primary paths.

4. The method of claim 3, further comprising computing the associations for the source schema and the target by chasing the primary paths with a plurality of referential integrity constraints in an XSD schema.

5. The method of claim 4, wherein an association comprises a relational view of any of the source schema or the target schema, that groups together the elements of the source schema that are semantically associated.

6. The method of claim 5, wherein the association describes one category of data that exists in an instance without violating any of a corresponding source schema or target schema.

7. The method of claim 1, further comprising finding a plurality of element-to-element correspondences.

8. The method of claim 7, wherein finding the plurality of element-to-element correspondences depends on previously computed associations.

9. The method of claim 7, wherein finding the plurality of element-to-element correspondences depends on a plurality of user-specified element-to-element correspondences.

10. The method of claim 7, further comprising taking no further action for a pair of associations if a relevant correspondences does not exist.

11. The method of claim 7, further comprising computing a logical mapping as an inter-schema constraint that asserts that a source association projected over a plurality of mapped source elements is contained in a target association projected over a plurality of mapped target elements.

12. The method of claim 11, further comprising generating a query that implements the inter-schema constraint at a data instance level.

13. The method of claim 12, further comprising using the query to transform all data under a category corresponding to the source association into data under a category corresponding to the target association, given a source data instance.

14. The method of claim 13, further comprising using the generated query to create at least one new value whenever there exists a target element that is not mapped via the element-to-element correspondences from the source schema.

15. The method of claim 14, wherein the target element created by the generated query is required by the target schema to be non-null and non-arbitrary.

16. The method of claim 12, further comprising using the generated query to group data according to a nesting hierarchy of an XSD schema, such that a set of resulting target data has no redundancy according to a partitioned normal form.

17. The method of claim 12, further comprising interacting with a user for each generated query to determine whether the query will be in a final result.

18. The method of claim 17, further comprising interacting with the user to eliminate a source association that is paired with a target association that does not need to be mapped.

19. The method of claim 18, further comprising generating a final query as a union of queries that are confirmed by the user.

20. The method of claim 19, wherein the final query is generated in an extensible style language transformation.

21. A computer program product having executable instruction codes for translating data from a source schema to a target schema, comprising:
a first set of instruction codes for compiling the source schema and the target schema;
a second set of instruction codes for translating a set of user specified correspondences from a plurality of elements of the source schema into a plurality of inter-schema constraints; and
a third set of instruction codes for translating the inter-schema constraints to a plurality of queries for translating the data.

22. The computer program product of claim 21, wherein the first set of instruction codes discovers a plurality of associations within the source schema and the target schema based on a plurality of referential constraints.

23. The computer program product of claim 21, further comprising a fourth set of instruction codes for compiling the source schema and the target schema into a nested relational representation comprising a set of primary paths.

24. The computer program product of claim 23, further comprising a fifth set of instruction codes for computing the associations for the source schema and the target by chasing the primary paths with a plurality of referential integrity constraints in an XSD schema.

25. The computer program product of claim 24, wherein an association comprises a relational view of any of the source schema or the target schema, that groups together the elements of the source schema that are semantically associated.

26. The computer program product of claim 25, wherein the association describes one category of data that exists in an instance without violating any of a corresponding source schema or target schema.

27. The computer program product of claim 21, further comprising a sixth set of instruction codes for finding a plurality of element-to-element correspondences.

28. The computer program product of claim 27, wherein the sixth set of instruction codes finds the plurality of element-to-element correspondences based on previously computed associations.

29. The computer program product of claim 27, wherein the sixth set of instruction codes finds the plurality of element-to-element correspondences based on a plurality of user-specified element-to-element correspondences.

30. The computer program product of claim 27, further comprising a seventh set of instruction codes for taking no further action for a pair of associations if a relevant correspondences does not exist.

31. A system for translating data from a source schema to a target schema, comprising:
means for compiling the source schema and the target schema;
means for translating a set of user specified correspondences from a plurality of elements of the source schema into a plurality of inter-schema constraints; and
means for translating the inter-schema constraints to a plurality of queries for translating the data.

32. The system of claim 31, wherein the means for compiling the source schema and the target schema the first set of instruction codes discovers a plurality of associations within the source schema and the target schema based on a plurality of referential constraints.

33. The system of claim 31, further comprising means for compiling the source schema and the target schema into a nested relational representation comprising a set of primary paths.

34. The system of claim 33, further comprising means for computing the associations for the source schema and the target by chasing the primary paths with a plurality of referential integrity constraints in an XSD schema.

35. The system of claim 34, wherein an association comprises a relational view of any of the source schema or the target schema, that groups together the elements of the source schema that are semantically associated.

36. The system of claim 35, wherein the association describes one category of data that exists in an instance without violating any of a corresponding source schema or target schema.

37. The system of claim 31, further comprising means for finding a plurality of element-to-element correspondences.

38. The system of claim 37, wherein the means for finding the plurality of element-to-element correspondences finds the plurality of element-to-element correspondences based on previously computed associations.

39. The system of claim 37, wherein the means for finding the plurality of element-to-element correspondences finds the plurality of element-to-element correspondences based on a plurality of user-specified element-to-element correspondences.

40. The system of claim 37, further comprising means for taking no further action for a pair of associations if a relevant correspondence does not exist.
